(19) United States
(12) Patent Application Publication
(10) Pub. No.: US 2006/0027948 A1
(43) Pub. Date: Feb. 9, 2006

(54) Mold resistant construction boards and methods for their manufacture

(76) Inventors: David E. Grass, Carmel, IN (US); John B. Letts, Carmel, IN (US); Wayne E. Laughlin, California, KY (US)

Correspondence Address: Jon Wood;Chief I.P. Counsel, Bridgestone Americas Holding, Inc., 1200 Firestone Parkway, Akron, OH, 44317, US

(21) Appl. No.: 11/177,784

(22) Filed: Jul. 8, 2005

Related U.S. Application Data
(60) Provisional application No. 60/586,424, filed on Jul. 8, 2004.

(51) Int. Cl. B32B 27/04; B32B 5/24; B32B 3/00

(52) U.S. Cl. 264/257; 428/318.4; 428/314.4; 428/311.11; 442/415; 442/370; 442/373; 442/123; 442/124; 162/145; 162/160

(57) ABSTRACT

A construction board comprising i) a foam layer, and ii) a first facer, where the first facer includes at least one mold-inhibiting agent.

This application claims the benefit of U.S. Provisional Application No. 60/586,424, filed Jul. 8, 2004, which is incorporated herein by reference.

### FIELD OF THE INVENTION

This invention relates to insulation construction boards, such as polyisocyanurate foam boards that include mold resistant facers.

### BACKGROUND OF THE INVENTION

In flat or low-slope roofing applications, insulation boards are typically adhered directly to a roof deck, which is most commonly constructed of concrete or steel. These insulation boards are typically closed-cell foams that include polyurethane or polyisocyanurate cellular materials with an insulating gas trapped within the cells. The insulation boards are then covered with a weather resistant membrane.

The insulation boards typically also include at least one facer material. The facer generally serves various functions; one, it acts as a carrier for the foam during the manufacturing process so the foam won't stick to the slats; second, it improves board dimensional stability especially early in the boards life; third, it is a convenient surface for application of asphalt or adhesives to tie the weather resistant membrane to the foam; and fourth, it increases board strength by spreading the load across the board and thereby increase wind uplift performance. A common facer includes a felt sheet that typically comprises cellulose fibers, glass fibers, binders, and sizing agents. Despite the fact that the insulation boards are covered with a weather-resistant membrane, moisture nonetheless develops around the insulation boards. This is especially true where the facer material has a propensity to attract or absorb moisture. It has been alleged that the presence of moisture around a surface may at times foster the growth of mold or other types of fungi or mildew. Therefore there is a general desire in the roofing industry as well as in every other segment of the construction industry to eliminate moisture around surfaces. Thus there is a need in the roofing industry to develop surfaces which are mold resistant.

Because the use of facers, particularly felt facers with insulation boards, has proved to be technologically useful, there is a need to overcome some of these shortcomings associated with their use.

### SUMMARY OF THE INVENTION

In general the present invention provides a construction board comprising i) a foam layer, and ii) a first facer, where the first facer includes at least one mold-inhibiting agent.

The present invention also includes a method for manufacturing a felt facer for use in the manufacture of construction boards, the method comprising i) providing an aqueous slurry of cellulose fibers and glass fibers, ii) depositing the aqueous slurry onto a felting mill to form a pre-facer, iii) incorporating a mold-inhibiting agent into the pre-facer and iv) drying the pre-facer to form a facer sheet.

The present invention further provides a method of manufacturing a construction board, the method comprising i) providing a facer sheet, ii) depositing a foam-forming material onto the facer sheet, iii) allowing the foam to rise, iv) directing the facer sheet and rising foam through a laminator, and v) applying a mold-inhibiting agent to the facer.

### BRIEF DESCRIPTION OF THE DRAWINGS

The FIGURE is a side-elevational view of a construction board.

### DETAILED DESCRIPTION OF ILLUSTRATIVE EMBODIMENTS

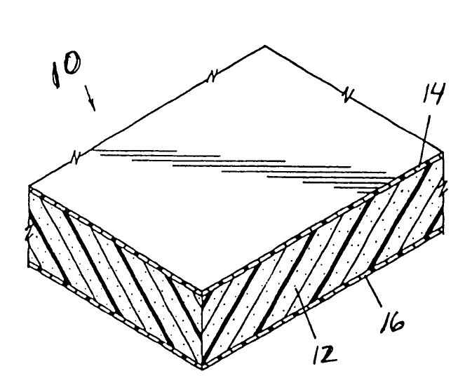

The foam construction boards of this invention include at least one facer that includes at least one mold-inhibiting agent. In one embodiment, as shown in FIG. 1, the construction board 10 includes a foam core or layer 12, first facer 14, and an optional second facer 16. In one or more embodiments, foam core 12 includes a first and second opposite horizontal or major surfaces, and first facer 14 is directly adjacent to a first major surface, and optional second facer 16 is directly adjacent to second major surface. Either first facer 14 or both first facer 14 and second facer 16 include at least one mold-inhibiting agent.

The foam core of layer 12 is preferably a closed-cell rigid foam structure. The cellular structure of the foam can include any thermoplastic or thermoset material that is capable of being foamed. In certain embodiments, these cells include an insulating material such as an insulating gas.

One embodiment of the closed-cell rigid cellular structure comprises a closed-cell foam. Preferably, substantially all of the cells of the foam are substantially devoid of open passages which allow airflow to or from the cell. Preferably the compressive strength in any direction is greater than about 5 psi, more preferably greater than about 10 psi, and even more preferably greater than about 15 psi. A representative diameter of a cell of the foam comprises from about 0.05 mm to about 1.0 mm, more preferably from about 0.1 mm to about 0.5 mm, and even more preferably about 0.2 mm. An example of a preferred density of the foam is about 1.0 lbf/ft³ to about 3.0 lbf/ft³, and more preferably from about 1.5 lbf/ft³ to about 2.5 lbf/ft³.

Another embodiment of the closed-cell rigid cellular structure is that of a foamed, cellular adhesive such as polyurethane which is described in U.S. Pat. No. 4,996,812 and is incorporated herein by reference. In one preferred embodiment, foam core or layer 12 includes a polyurethane or a polyisocyanurate cellular structure. These foams are conventional in the art as described in U.S. Pat. Nos. 6,182,309, 5,367,000, 5,000,005, and 6,117,375, which are incorporated herein by reference.

In general the boards of the present invention are preferably produced by developing or forming a polyurethane and/or polyisocyanurate foam in the presence of a blowing agent. The foam is preferably prepared by contacting an A-side stream of reagents with a B-side stream of reagents and depositing the mixture or developing foam onto a laminator. In one embodiment the A-side stream includes an isocyanate and the B-side includes an isocyanate-reactive compound.

The A-side stream typically only contains the isocyanate, but, in addition to isocyanate components, the A-side stream may contain flame-retardants, surfactants, blowing agents and other non-isocyanate-reactive components.

Suitable isocyanates are generally known in the art. Useful isocyanates include aromatic polyisocyanates such as diphenyl methane, diisocyanate in the form of its 2,4′-, 2,2′-, and 4,4′-isomers and mixtures thereof, the mixtures of diphenyl methane diisocyanates (MDI) and oligomers thereof known in the art as “crude” or polymeric MDI having an isocyanate functionality of greater than 2, toluene diisocyanate in the form of its 2,4′ and 2,6′-isomers and mixtures thereof, 1,5-naphthalene diisocyanate, and 1,4′diisocyanatobenzene. Preferred isocyanate components include polymeric Rubinate 1850 (Huntsmen Polyurethanes), polymeric Lupranate M70R, and polymeric Mondur 489N (Bayer).

The B-side stream, which contains isocyanate reactive compounds, may also include flame retardants, catalysts, emulsifiers/solubilizers, surfactants, blowing agents fillers, fungicides, anti-static substances, water and other ingredients that are conventional in the art.

The preferred isocyanate-reactive component is a polyol. The terms polyol or polyol component include diols, polyols, and glycols, which may contain water as generally known in the art. Primary and secondary amines are suitable, as are polyether polyols and polyester polyols. Useful polyester polyols include phthalic anhydride based PS-2352 (Stepen), phthalic anhydride based polyol PS-2412 (Stepen), teraphthalic based polyol 3522 (Kosa), and a blended polyol TR 564 (Oxid). Useful polyether polyols include those based on sucrose, glycerin, and toluene diamine. Examples of glycols include diethylene glycol, dipropylene glycol, and ethylene glycol. Of these, a particularly preferred glycol is diethylene glycol. Suitable primary and secondary amines include, without limitation, ethylene diamine, and diethanolamine. The preferred polyol is a polyester polyol, and the present invention is preferably practiced in the appreciable absence of any polyether polyol. Most preferably, the ingredients are devoid of polyether polyols.

Catalysts are believed to initiate the polymerization reaction between the isocyanate and the polyol, as well as a trimerization reaction between free isocyanate groups when polyisocyanurate foam is desired. While some catalysts expedite both reactions, it is common to employ two or more catalysts to achieve both reactions. Useful catalysts include salts of alkali metals and carboxylic acids or phenols, such as, for example potassium octoate; mononuclear or polynuclear Mannich bases of condensable phenols, oxo-compounds, and secondary amines, which are optionally substituted with alkyl groups, aryl groups, or aralkyl groups; tertiary amines, such as pentamethyldiethylene triamine (PMDETA), 2,4,6-tris[(dimethylamino)methyl]phenol, triethyl amine, tributyl amine, N-methyl morpholine, and N-ethyl morpholine; basic nitrogen compounds, such as tetra alkyl ammonium hydroxides, alkali metal hydroxides, alkali metal phenolates, and alkali metal acholates; and organic metal compounds, such as tin(II)-salts of carboxylic acids, tin(IV)-compounds, and organo lead compounds, such as lead naphthenate and lead octoate.

Surfactants, emulsifiers, and/or solubilizers may also be employed in the production of polyurethane and polyisocyanurate foams in order to increase the compatibility of the blowing agents with the isocyanate and polyol components.

In one embodiment, the surfactants serve two purposes. First, they help to emulsify/solubilize all the components so that they react completely. Second, they promote cell nucleation and cell stabilization. Typically, the surfactants are silicone co-polymers or organic polymers bonded to a silicone polymer. Although surfactants can serve both functions, a more cost effective method to ensure emulsification/solubilization is to use enough emulsifiers/solubilizers to maintain emulsification/solubilization and a minimal amount of the surfactant to obtain good cell nucleation and cell stabilization. Examples of surfactants include Pelron surfactant 9868A, Goldschmidt surfactant B8469, and CK-Witco's L 6912. U.S. Pat. Nos. 5,686,499 and 5,837,742 are incorporated herein by reference to show various useful surfactants.

Suitable emulsifiers/solubilizers include DABCO Kitane 20AS (Air Products), and Tergitol NP-9 (nonylphenol+9 moles ethylene oxide).

Flame Retardants are commonly used in the production of polyurethane and polyisocyanurate foams, especially when the foams contain flammable blowing agents such as pentane isomers. Useful flame retardants include tri(monochloropropyl) phosphate, tri-2-chloroethyl phosphate, phosphonic acid, methyl ester, dimethyl ester, and diethyl ester. U.S. Pat. No. 5,182,309 is incorporated herein by reference to show useful blowing agents.

Useful blowing agents include isopentane, n-entane, cyclopentane, alkanes, (cyclo)alkanes, hydrofluorocarbons, hydrochlorofluorocarbons, fluorocarbons, fluorinated ethers, alkenes, alkynes, carbon dioxide, and noble gases.

First facer 14 can comprise any facer material that is capable of being modified with a mold-inhibiting agent. Second facer 16 may likewise include material capable of being modified with a mold-inhibiting agent or may include facers that are not conducive to this modification; for example foil facers may not be easily modified to include a mold-inhibiting agent. Facers that are capable of being modified with a mold-inhibiting agent include cellulose facers, fiberglass facers, cellulose/fiberglass blend facers (a.k.a. felt facers).

Any compound that inhibits mold growth, either by preventing mold growth or by exterminating existing mold, and is capable of being incorporated into first facer 14, can be used in practicing this invention. Types of mold-inhibiting compounds include boron-containing compounds, copper salts, organo metal halide salts, organo-aluminum halide salts and mixtures thereof. Other mold-inhibiting agents include chlorothalonil, methylene bisthiocyanate, phosmidosin, chlorpyrifos, hexacomazole, katapin, thiabendazole, salicyl analide and mixtures thereof including mixtures with other mold-inhibiting agents defined herein.

Exemplary boron-containing compounds include zinc borate disodiumoctaborate tetrahydrate, boric acid, borax, disodium orthoborate, sodium borate, calcium borate, calcium metaborate, and mixtures thereof.

Exemplary copper salts include copper sulfate, copper naphthenate, copper ammonium acetate, and mixtures thereof.

Exemplary organo metal halide salts include sodium tetrachlorophenate, benzaalkonium chloride, and mixtures thereof.

Exemplary organo-ammonium halide salts include ammonium fluosilicate, trimethyl ammonium chloride, cetapyridinium chloride, and mixtures thereof.

First facer 14 and optionally second facer 16 may include that amount of mold-inhibiting agent that will have an appreciable affect on the presence or growth of mold on or within the facer. In one embodiment, first facer 14 and optionally second facer 16 will each respectively include from about 1 to about 50% by weight mold-inhibiting agent, in other embodiments from about 2 to about 35% by weight mold-inhibiting agent, in other embodiments from about 5 to about 30% by weight mold-inhibiting agent, and in other embodiments from about 10 to about 25% by weight mold-inhibiting agent based on the entire weight of the facer.

In one embodiment, first facer 14, and optionally second facer 16, is a felt facer. Useful felt facers are typically about 0.005 inches to about 0.050 inches thick, and in other embodiments from about 0.010 inches to about 0.030 inches thick. These facers typically include cellulose fibers, glass fibers, at least one mold-inhibiting agent, an optional binder, and an optional sizing agent. Similar felt facers, excluding the mold-inhibiting agent, are disclosed in U.S. Pat. No. 5,776,841 and U.S. Publication No. 2003/0032351, which is incorporated therein by reference.

The cellulose fibers may be obtained from a variety of sources including recycled paper products (corrugated cardboard, news print, magazines), rags and materials based on cellulose. Most plant derived materials are based on cellulose.

The glass fibers are typically characterized by having a diameter of from about 5 to about 1,000 microns and preferably from about 10 to about 100 microns. The length of the glass fibers is typically from about 0.25 to about 5 inches and preferably from about 0.5 to about 3.0 inches. Further, the glass fibers are generally characterized by having an aspect ratio from about 0.25 to about 25,000 and preferably from about 9,000 to about 12,000.

Any of the mold-inhibiting agents described above can be employed in practicing this particular embodiment. In one or more embodiments, a combination of mold-inhibiting agents is employed. For example, in one embodiment, three separate borate compounds are employed. These borates include sodium borate, calcium borate, and calcium metaborate. The ratio of sodium borate to calcium borate can be from about 1:100 to about 100:1 and in other embodiments from about 1 to about 10. The ratio of calcium borate to calcium metaborate can be from about 1:100 to about 100:1 and in other embodiments from about 2 to about 1.

Any of the binders typically employed in preparing felt facers may be included in the facers of this invention. Types of binders include starch, wood rosin and alum.

Any of the various sizing agents employed in felt facers can be employed in practicing this invention.

In one or more embodiments, the felt paper includes from about 70 to about 90% by weight cellulose fibers, from about 6 to about 30% by weight glass fibers, from about 3 to about 25 by weight mold-inhibiting agent, from about 0.5 to about 10% by weight binder, and from about 0.25 to about 6% by weight sizing agent, based on the entire weight of the felt facer. In other embodiments, the felt paper includes from about 75 to about 85% by weight cellulose fibers, from about 10 to about 18% by weight glass fibers, from about 5 to about 20% by weight mold-inhibiting agent, from about 1 to about 5% by weight binder, and from about 0.5 to about 2% by weight sizing agent, based on the entire weight of the felt facer. In other embodiments, the felt facer includes from about 80 to about 84% by weight cellulose fibers, from about 12 to about 15% by weight glass fibers, from about 10 to about 15% by weight mold-inhibiting agent, from about 1.5 to about 3.0% by weight binder, and from about 0.5 to about 1% by weight sizing agent, based on the entire weight of the felt facer.

Various techniques can be employed to incorporate the mold-inhibiting agent into or onto the facer. The technique chosen may vary based upon the composition and method of manufacture of the facer. In general, the mold-inhibiting agents can be incorporated into or onto the facer as part of the facer manufacturing process, as a pre-treatment to a facer that has been manufactured but not yet incorporated into a construction board, or as a post treatment to the facer after it has been incorporated into the construction board.

With respect to felt facers, those skilled in the art appreciate that felt facers are generally manufactured by using processes similar to those employed in the paper-manufacturing art. For example, an aqueous slurry of the cellulose fibers, glass fibers, binder and sizing agent is prepared and formed into a sheet on a felting mill (e.g., typically a wire mesh or screen). The sheet is pressed, drained, and ultimately dried to produce the felt sheet.

In one embodiment, the mold-inhibiting agent can be added to or incorporated into the aqueous slurry and therefore is deposited onto the felting mill along with the other constituents of the slurry. In other embodiments, the mold-inhibiting agent selected will be insoluble in aqueous solutions, which will facilitate capture of the mold-inhibiting agent on the felting mill and ultimately onto the felt sheet.

In another embodiment, the mold-inhibiting agent can be applied to the felt sheet after the slurry is deposited onto the felting mill but before or during one or more of the subsequent processing steps such as pressing, draining, or drying takes place. For example, where the mold-inhibiting agent is liquid or provided as a solution (e.g., wither solvent or aqueous solution), the mold-inhibiting agent can be sprayed onto the felt sheet after the slurry is deposited onto the felting mill. The step of spraying can occur any time prior to drying. For example, where the mold-inhibiting agent is a solid, the mold-inhibiting agent can be provided as a particulate or as a powder and deposited onto the prefelt after the slurry has been deposited onto the felting screen. Again, the step of depositing the mold-inhibiting agent onto the felt can occur any time between the step of depositing the slurry onto the felting mill and the ultimate step of drying. In yet another embodiment, especially where a solution or liquid mold-inhibiting agent is provided, the felt sheet can be submerged into a bath of the mold-inhibiting agent in order to saturate the felt sheet with the mold-inhibiting agent. This step of submerging the felt sheet within a bath can occur at any point after the slurry is deposited onto the felt screen and is typically followed by draining and drying steps. In still another example, combinations or mixtures of the foregoing steps can be employed to apply one or more mold-inhibiting agents to the felt sheet.

For example, enough sodium borate is added as a concentrated solution or solid (or in the slurry itself) itself to incorporate 5% by weight sodium borate (based on the total mold resistant package). Then, just after the slurry is laid down on the feltline, 50% by weight (based on the total mold resistant package) of calcium metaborate is added. Subsequently, the remaining 45% by weight of the mold resistant package is added as calcium borate when the sheet is moist.

In one particular embodiment, the facer can be treated to incorporate mold-inhibiting agent into or onto the facer after manufacture of the facer but prior to incorporation into the construction board. Also, combinations of various techniques can be employed. In one embodiment, mold-inhibiting agents are incorporated into the facer during manufacture of the facer and additional (either in amount or in kind) mold-inhibiting agent is added as a pre-treatment to the facer prior to incorporation into the construction board. For example, in one embodiment, a pre-manufactured facer can be subsequently submerged into a bath that includes a liquid or solution of a mold-inhibiting agent. Following the step of submerging the facer, the facer can optionally be pressed and dried. In another embodiment, a solution or liquid form of the mold-inhibiting agent can be sprayed onto the pre-manufactured facer. If the mold-inhibiting agent is a solid material, the solid mold-inhibiting agent can be applied to the pre-manufactured facer as a solid either alone or in combination with a binder.

As also noted above, the mold-inhibiting agent can be incorporated into or onto the facer after manufacture of the construction board. This technique can be used as the exclusive method for incorporating the mold-inhibiting agent or it can be used in combination with one or more techniques. As is known in the art, the facer sheet (e.g., a felt sheet) is unrolled in the construction board manufacturing process and the foam precursor chemical or chemicals are poured onto the unrolled facer. As the foam spreads, it enters a laminator where it rises to contact a restricted upper portion of the laminator or the face of a second felt sheeting and hardens thereon. The construction boards, which are typically only partially cured before leaving the production line, can be cut to the length. After cutting, the boards are removed from the production line and typically stacked and stored at which time a full cure typically develops.

In one embodiment, a solution or liquid form of the mold-inhibiting agent can be sprayed onto the facer after the foam is formed. If the mold-inhibiting agent is a solid material, the solid mold-inhibiting agent can be applied to the facer as a solid either alone or in combination with a binder after the foam is formed. For example, a stirred, aqueous slurry of approximately 75/25 sodium borate/calcium borate is applied via a fine mist onto the top and bottom facers of the board as it exits the laminator. The facers are heated briefly and then stacked.

The construction boards of this invention are useful as insulation boards in flat or low-slope roofing constructions. They are also useful as sheathing in commercial and residential wall constructions.

### PROPHETIC EXAMPLE

A felt facer sheet is prepared employing techniques similar to those described in U.S. Pat. No. 5,776,841 except that mold-inhibiting agents are incorporated onto and into the felt sheet as part of the manufacturing process of the felt sheet. After the aqueous slurry of cellulose fibers, glass fiber, binder, and sizing agent is deposited onto a felting mill, a combination of boron-containing mold-inhibiting agents are applied to the facer material. Specifically, the mold-inhibiting agents include sodium borate, calcium borate, and calcium metaborate. The location within the manufacturing process at which the various borates are added is varied to achieve desired properties. For example, certain borates can be more evenly distributed through the thickness of the facer by applying the borate soon after the aqueous slurry is applied to the felting mill. By applying the borate soon after the slurry is placed onto the felting mill, the subsequent pressing and drying steps will help to pull the borate, which is a solid, through the thickness of the sheet. The tradeoff is that some of the borate will be lost as it is carried away with the water being removed from the pre-facer slurry.

As the borates are applied to the facer further into the manufacturing process (i.e., later in time from when the slurry is deposited onto the felting mill), a greater amount of borate will ultimately be incorporated at or near the top of the facer. An advantage of incorporating the mold-inhibiting agents into the upper portion of the felt sheet (e.g., at or near the top of the felt sheet) may prove to be useful in the manufacture of the construction boards. In other words, foam can be applied onto that surface of the facer material that does not include a high concentration of the mold-inhibiting agent. As a result, the foam will be bonded to the side without high levels of mold-inhibiting agent and yet the insulation board will nonetheless have an upper barrier of mold-inhibiting agent.

Also, less borate will be lost as a result of being carried away with the water. Also, the variance in solubility of the various borates within water can be taken advantage of in order to alter the incorporation of the borates into the facer. For example, those materials that are less soluble in water can be added sooner in the manufacturing process (i.e., immediately after the slurry is deposited on the felting mill), and those that have greater solubility in water can be added later in the manufacturing process (e.g., immediately prior to pressing and draining or after pressing and draining).

Various modifications and alterations that do not depart from the scope and spirit of this invention will become apparent to those skilled in the art. This invention is not to be duly limited to the illustrative embodiments set forth herein.

What is claimed is:

1. A construction board comprising:
a foam layer; and
a first facer, where the first facer includes at least one mold-inhibiting agent.

2. The construction board of claim 1, where the first facer is attached to a first horizontal surface of the foam layer, and where the construction board includes a second facer attached to a second horizontal surface of the foam layer.

3. The construction board of claim 1, where the foam layer comprises a closed cell, rigid cellular structure.

4. The construction board of claim 3, where the cellular structure comprises polyurethane or polyisocyanurate cellular material.

5. The construction board of claim 1, where the first facer comprises a felt facer, and where the felt facer comprises cellulose fibers and glass fibers.

6. The construction board of claim 5, where the felt facer comprises cellulose fibers characterized by a diameter of from about 5 to about 1,000 microns and an aspect ratio of from about 0.25 to about 25,000.

7. The construction board of claim 8, where the facer material includes from about 70 to about 90% by weight of the cellulose fibers, from about 6 to about 30% by weight of the glass fibers, from about 0.5 to about 10% by weight of a binder, from about 0.25 to about 6% by weight of a sizing agent, and from about 3 to about 25% by weight of a mold-inhibiting agent, based on the entire weight of the felt facer.

8. The construction board of claim 1, where the mold-inhibiting agent includes sodium borate, calcium metaborate, calcium borate, zinc borate, boric acid, borax, disodium orthoborate, copper sulfate, sodium tetrachlorophenate, ammonium fluorosilicate, and trimethyl ammonium chloride, and mixtures thereof.

9. A method for manufacturing a felt facer for use in the manufacture of construction boards, the method comprising:
providing an aqueous slurry of cellulose fibers and glass fibers;
depositing the aqueous slurry onto a felting mill to form a pre-facer;
incorporating a mold-inhibiting agent into the pre-facer; and
drying the pre-facer to form a facer sheet.

10. The method of claim 9, where said step of incorporating the mold-inhibiting agent includes incorporating one or more of sodium borate, calcium metaborate, calcium borate, zinc borate, boric acid, borax, disodium orthoborate copper sulfate, sodium tetrachlorophenate, ammonium fluorosilicate, trimethyl ammonium chloride, and mixtures thereof.

11. A method of manufacturing a construction board, the method comprising:
providing a facer sheet;
depositing a foam-forming material onto the facer sheet;
allowing the foam to rise;
directing the facer sheet and rising foam through a laminator; and
applying a mold-inhibiting agent to the facer.

12. The method of claim 9, wherein said incorporating comprises adding the mold-inhibiting agent to said aqueous slurry.

13. The method of claim 9, wherein said incorporating comprises applying said mold-inhibiting agent is applied to said pre-facer after the step of depositing the aqueous slurry onto the felting mill to form the pre-facer, but before or during one or more of the subsequent steps.

14. The method of claim 9, where said incorporating comprises adding one or more of the said mold-inhibiting agents to said pre-facer during one or more of the steps of:
said providing an aqueous slurry of cellulose fibers and glass fibers;
said depositing the aqueous slurry onto a felting mill to form a pre-facer; or
said drying the pre-facer to form a pre-facer sheet.

15. The method of claim 14, where said incorporating comprises:
adding 5% of the mold-inhibiting agent as a concentrated solution to said aqueous slurry;
adding 50% of the mold-inhibiting agent during said depositing; and,
adding 45% of the mold-inhibiting agent before or during said drying.

16. The method of claim 14, where said incorporating comprises:
adding 5% of the mold inhibiting agent as a solid to said aqueous slurry;
adding 50% of the mold-inhibiting agent during said depositing; and,
adding 45% of the mold-inhibiting agent before or during said drying.

17. The method of claim 11, wherein said mold-inhibiting agent comprises a solid and said applying comprises adhering said agent to the facer with a binder.

18. The method of claim 17, where said applying is substantially free of the use of a binder.

19. The method of claim 11, where said mold-inhibiting agent comprises an aqueous slurry and said applying comprises spraying the slurry onto the facer of said construction board as said board exits the laminator.
